(19) United States
(12) Patent Application Publication
(10) Pub. No.: US 2019/0153220 A1
(43) Pub. Date: May 23, 2019

(54) POLYESTERCARBONATE COMPOSITIONS, ARTICLES FORMED THEREFROM, AND METHODS OF MANUFACTURE

(71) Applicant: SABIC GLOBAL TECHNOLOGIES B.V., BERGEN OP ZOOM (NL)

(72) Inventors: SHAMSUL HAIRI SALLEH, SHIMOTSUKE, TOCHIGI (JP); HIROSHI MIYAKE, UTSUNOMIYA, TOCHIGI (JP)

(21) Appl. No.: 16/313,227

(22) PCT Filed: Jun. 27, 2017
(86) PCT No.: PCT/IB2017/053840

§ 371 Date: Dec. 26, 2018

Related U.S. Application Data
(60) Provisional application No. 62/355,435, filed on Jun. 28, 2016.

(51) Int. Cl. C08L 69/00; C08G 63/64; C08J 5/18; B32B 27/08; B32B 27/36

(52) U.S. Cl. CPC C08L 69/005; C08G 63/64; C08L 69/00; C08J 5/18; C08J 2469/00; B32B 27/365; C08L 2205/025; C08J 2369/00; B32B 27/08

(57) ABSTRACT

A thermoplastic composition comprising, based on the total weight of the composition: 1 to 100 wt. % of a poly(aliphatic ester-carbonate) having a weight average molecular weight of 50,000 g/mol to 200,000 g/mol as measured by gel permeation chromatography using polystyrene standards, the poly(aliphatic ester-carbonate) comprising carbonate units of the formula (I) (I) and ester units of the formula (II) (II) wherein: T is a C₆₋₂₀ alkylene; R¹is a C₆₋₃₀ aromatic group; and J is a C₂₋₁₀ alkylene, a C₆₋₂₀cycloalkylene, a C₆₋₂₀arylene, or a polyoxyalkylene in which the alkylene groups contain 2 to 6 carbons; and 0 to 99 wt. % of a bisphenol A homopolycarbonate having a weight average molecular weight of 50,000 g/mol to 200,000 g/mol as measured by gel permeation chromatography using polystyrene standards; wherein the thermoplastic composition has a heat deflection temperature of 100 ° C. to 130 ° C. determined in accordance with ASTM D648 at 1.6 MPa.

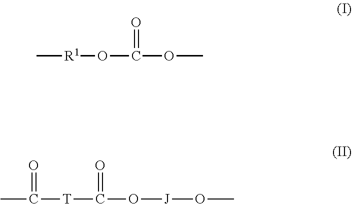

### BACKGROUND

This disclosure generally relates to polycarbonate compositions, and more particularly, to polyestercarbonate compositions, methods of manufacture, and uses thereof.

Polycarbonates are useful in the manufacture of articles and components for a wide range of applications, from automotive parts to electronic appliances. Because of their broad use, particularly in multi-layer films such as cards that are subjected to repeated use for a prolonged period of time, it is desirable to provide polycarbonates with good mechanical strength, particularly polycarbonates that is capable of providing films having high durability and resistance to cracking. It would be a further advantage if the polycarbonate compositions have good mechanical strength while at the same time meet the low gel generation, ease of lamination, and low warpage needs.

### SUMMARY

A thermoplastic composition comprises, based on the total weight of the composition: 1 to 100 wt. % of a poly(aliphatic ester-carbonate) having a weight average molecular weight of 50,000 g/mol to 200,000 g/mol as measured by gel permeation chromatography using polystyrene standards, the poly(aliphatic ester-carbonate) comprising carbonate units of the formula

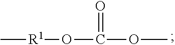

and ester units of the formula

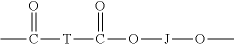

wherein: T is a C₆₋₂₀ alkylene; R¹ is a C₆₋₃₀ aromatic group; and J is a C₂₋₁₀ alkylene, a C₆₋₂₀ cycloalkylene, a C₆₋₂₀ arylene, or a polyoxyalkylene in which the alkylene groups contain 2 to 6 carbon; and 0 to 99 wt. % of a bisphenol A homopolycarbonate having a weight average molecular weight of 50,000 g/mol to 200,000 g/mol as measured by gel permeation chromatography using polystyrene standards; wherein the thermoplastic composition has a heat deflection temperature of 100° C. to 130° C. determined in accordance with ASTM D648 at 1.6 MPa.

In another embodiment, disclosed is an article wherein the article a molded article, a thermoformed article, an extruded sheet, one or more layers of a multi-layer article, a substrate for a coated article, or a substrate for an article made from the above-described thermoplastic composition.

In still another embodiment, a method of manufacture of an article comprises laminating, extruding or co-extruding, calendaring, injection molding, blow molding, film casting, or coating the above-described thermoplastic composition.

The above described and other features are exemplified by the following drawings, detailed description, examples, and claims.

### DETAILED DESCRIPTION

It has now been found that thermoplastic compositions containing a high molecular weight poly(aliphatic ester-carbonate) having ester units derived from alpha, omega aliphatic dicarboxylic acids, and optionally a high molecular weight bisphenol A homopolycarbonate are effective to provide articles having excellent mechanical strength. In particular, articles made from the thermoplastic compositions can have high durability and resistance to cracking. In some embodiments, the thermoplastic compositions are suitable for making sheets that can be conveniently laminated with other layers, have low gel formation, or low warpage. Articles comprising the thermoplastic compositions can also have one or more of the following properties: good optical quality; improved chemical resistance; improved hydrolytic stability; good fatigue performance; excellent colorability; or good low temperature ductility.

As used herein, the high molecular weight poly(aliphatic ester-carbonate)s are polycarbonates having a weight average molecular weight of 50,000 grams per mole (g/mol) to 200,000 g/mol, preferably 50,000 g/mol to 100,000 g/mol, more preferably 60,000 g/mol to 80,000 g/mol, even more preferably 65,000 g/mol to 75,000 g/mol, as measured by gel permeation chromatography (GPC) using polystyrene standards. GPC samples are prepared at a concentration of 1 milligram per milliliter and are eluted at a flow rate of 0.6 ml/min with chloroform as the eluent using a crosslinked styrene-divinyl benzene column.

The high molecular weight poly(aliphatic ester-carbonate)s comprise carbonate units of formula (1) and ester units of formula (2)

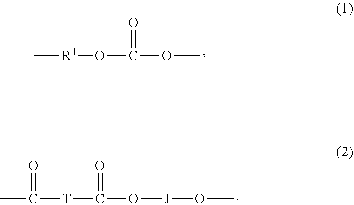

In formula (1), at least 60 percent of the total number of R¹ groups are aromatic, or each W contains at least one C₆₋₃₀ aromatic group. Specifically, each W can be derived from a dihydroxy compound such as an aromatic dihydroxy compound of formula (3) or a bisphenol of formula (4).

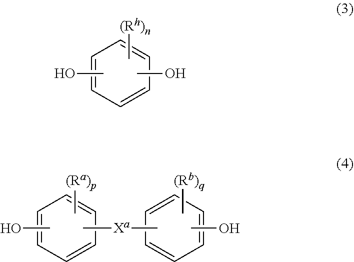

In formula (3), each Rh is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆-10 aryl, and n is 0 to 4.

In formula (4), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O), —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})—wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Examples of dihydroxy compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha'-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”). BPA is specifically mentioned.

In formula (2), J is a divalent group derived from a dihydroxy compound (which includes a reactive derivative thereof), and can be, for example, a C₂₋₁₀ alkylene, a C₆₋₂₀ cycloalkylene a C₆₋₂₀ arylene, or a polyoxyalkylene group in which the alkylene groups contain 2 to 6 carbon atoms, specifically, 2, 3, or 4 carbon atoms; and T is a divalent group derived from an alpha, omega linear aliphatic dicarboxylic acid (which includes a reactive derivative thereof), and can be, for example, a C₆₋₂₀ alkylene, preferably a C₆₋₁₂ linear alkylene, more preferably a linear C₈ alkylene. Copolyesters containing a combination of different T or J groups can be used. The polyester units can be branched or linear.

Specific dihydroxy compounds include aromatic dihydroxy compounds of formula (3) (e.g., resorcinol), bisphenols of formula (4) (e.g., bisphenol A), a C₁₋₈ aliphatic diol such as ethane diol, n-propane diol, i-propane diol, 1,4-butane diol, 1,6-cyclohexane diol, 1,6-hydroxymethylcyclohexane, or a combination comprising at least one of the foregoing dihydroxy compounds. Preferably, J is derived from bisphenol A.

Alpha, omega linear aliphatic dicarboxylic acids that can be used include C₆₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA).

The molar ratio of ester units to carbonate units in the poly(aliphatic ester-carbonate)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(aliphatic ester-carbonate)s can vary from 1:99 to 30:70, specifically 2:98 to 25:75, more specifically 3:97 to 20:80, or from 5:95 to 15:85. In an embodiment, the poly(aliphatic ester-carbonate)s comprise 1 to 30 mol % of ester units based on the total moles of the carbonate units and ester units in the poly(aliphatic ester-carbonate)s.

A preferred poly(aliphatic ester-carbonate) is of formula:

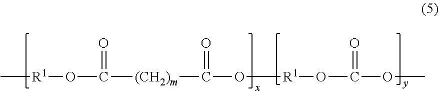

wherein each R¹ can be the same or different, and is as described in formula (1), m is 4 to 18, preferably 4 to 10, more preferably 8, and the average molar ratio of ester units to carbonate units x:y is 99:1 to 1:99, including 13:87 to 2:98, or 9:91 to 2:98, or 8:92 to 2:98. In a preferred embodiment, the poly(aliphatic ester-carbonate)s comprise bisphenol A sebacate ester units and bisphenol A carbonate units, having an average molar ratio of x:y of 2:98 to 8:92, for example 6:94.

Optionally the thermoplastic compositions include a bisphenol A homopolycarbonate having a weight average molecular weight of 50,000 g/mol to 200,000 g/mol, preferably 50,000 g/mol to 100,000 g/mol, more preferably 60,000 g/mol to 80,000 g/mol, even more preferably 65,000 g/mol to 75,000 g/mol, as measured by gel permeation chromatography (GPC) using polystyrene standards. (Also referred to as “high molecular weight bisphenol A homopolycarbonate) GPC samples are prepared at a concentration of 1 milligram per milliliter and are eluted at a flow rate of 0.6 ml/min with chloroform as the eluent using a crosslinked styrene-divinyl benzene column. The bisphenol A homopolycarbonate can be a linear polymer or a branched polymer.

Polycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example monocyclic phenols such as phenol, p-cyanophenol, and C₁-C₂₂ alkyl-substituted phenols such as p-cumyl-phenol, resorcinol monobenzoate, and p-and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used. Branched polycarbonate blocks can be prepared by adding a branching agent during polymerization, for example trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt. %. Combinations comprising linear polycarbonates and branched polycarbonates can be used.

The thermoplastic compositions can comprise 1 to 100 wt. % of the high molecular weight poly(aliphatic ester-carbonate) and 0 to 99 wt. % of the high molecular weight bisphenol A homopolycarbonate, each based on the total weight of the thermoplastic compositions. Preferably, the thermoplastic compositions comprise 20 to 80 wt. % of the high molecular weight poly(aliphatic ester-carbonate) and 20 to 80 wt. % of the high molecular weight bisphenol A homopolycarbonate, each based on the total weight of the thermoplastic compositions.

The thermoplastic compositions can have a heat deflection temperature of 100° C. to 130° C. determined in accordance with ASTM D648 at 1.6 MPa. In an embodiment, the thermoplastic compositions have a heat deflection temperature of 110° C. to 120° C. determined in accordance with ASTM D648 at 1.6 MPa.

The thermoplastic compositions can have a glass transition temperature of 130° C. to 150° C. determined by differential scanning calorimetry as per ASTM D3418 with a 20° C./min heating rate, which make the thermoplastic compositions suitable for use in a process requiring a hot press temperature of 130° C. to 150° C.

The thermoplastic compositions can have reduced gel generation when it is used to make films or sheets. In an embodiment, a sheet of the thermoplastic compositions has no observable specks or gels over an area of at least 3 square meters when viewed at a distance of 0.3 meter without magnification.

Articles formed from the thermoplastic compositions have improved durability. An injection molded article of the thermoplastic composition having a thickness of 1.0 mm does not break after bending 5 times, or 8 times, or 12 times.

To obtain the balanced durability and film forming properties, the thermoplastic compositions have a weight average molecular weight of 50,000 g/mol to 200,000 g/mol, preferably 50,000 g/mol to 100,000 g/mol, more preferably 60,000 g/mol to 80,000 g/mol, even more preferably 65,000 g/mol to 75,000 g/mol, as measured by gel permeation chromatography (GPC) using polystyrene standards. GPC samples are prepared at a concentration of 1 milligram per milliliter and are eluted at a flow rate of 0.6 ml/min with chloroform as the eluent using a crosslinked styrene-divinyl benzene column.

The thermoplastic compositions can include various additives ordinarily incorporated into polymer compositions of this type, with the proviso that the additive(s) are selected so as to not significantly adversely affect the desired properties of the thermoplastic composition, in particular melt flow, thermal, transparency, and surface properties. Such additives can be mixed at a suitable time during the mixing of the components for forming the composition. Additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, anti-drip agents, and impact modifiers. In an embodiment, the thermoplastic composition further comprises a processing aid, a heat stabilizer, an ultraviolet light absorber, a colorant, a flame retardant, an impact modifier, or a combination thereof. A combination of additives can be used, for example a combination of a heat stabilizer, mold release agent, and ultraviolet light stabilizer. In general, the additives are used in the amounts generally known to be effective. For example, the total amount of the additives (other than any impact modifier, filler, or reinforcing agents) can be 0 to 5 wt. % or 0.01 to 5 wt. %, based on the total weight of the thermoplastic composition.

Shaped, formed, or molded articles comprising the thermoplastic compositions are also provided. The compositions can be molded into useful shaped articles by a variety of methods, such as laminating, extruding or co-extruding, calendaring, injection molding, blow molding, film casting, or coating. The article can be a molded article, a thermoformed article, an extruded sheet, one or more layers of a multi-layer article, a substrate for a coated article, or a substrate for an article made from the thermoplastic composition. “Films” and “sheets” are used interchangeably herein.

Preferably, the article is a multi-layer sheet or a heat sensitive pigment containing sheet. The multi-layer sheet can comprise a base layer comprising the thermoplastic composition and a cap layer disposed on a side of the base layer. The cap layer comprising an acrylic, polyester, or the thermoplastic composition as described herein. The cap layer can be disposed on one or both surfaces of the base layer. When a cap layer is disposed on both surfaces of the base layer, a first cap layer disposed on one surface of the base layer can be the same or different as a second cap layer disposed on the opposing surface of the base layer. In an embodiment, the multi-layer sheets further comprise an embedded integrated circuit.

The multilayer sheets can be prepared by coextrusion, laminating, calendaring, injection molding, or other method suitable for preparing a multilayer sheet. In a specific embodiment, the multilayer sheet is prepared by coextrusion. In a continuous calendaring co-extrusion process, first and second single screw extruders can supply polymer melts for the individual layers (i.e., the base layer and the cap layers disposed on either side of the base layer) into a feed block of an extruder apparatus. A die forms a molten polymeric web that is fed to a three-roll calendaring stack. Commonly, such a calendaring stack can comprise two to four counter-rotating cylindrical rolls with each roll, individually, made from metal (e.g., steel) or rubber coated metal. Each roll can be heated or cooled, as is appropriate.

The molten web formed by the die can be successively squeezed between the calendaring rolls. The inter-roll clearance (“nip”) through which the web is drawn determines the thickness of the layers.

After passing through the nip, the molten web can be cooled (e.g., to a temperature less than the T_{g} of the molten material), and can then be passed through pull rolls. A mask can optionally be applied to the cooled sheet to protect the sheet from damage or contamination. The resulting material can be put onto a winder to supply product in roll form, cut on-line into sheeted material, or optionally the roll form can be sheeted off-line and cut into lengths suitable for handling.

In various embodiments, the calendaring roll(s) can comprise a polished roll (e.g., a chrome or chromium plated roll). In other embodiments, the roll(s) can comprise a textured roll (e.g., a roll comprising an elastomeric material (e.g., an EPDM (ethylene propylene diamine monomer) based rubber)), a compliant textured steel roller or belt system, or a textured steel roller (e.g., a roll textured with grit blasting). Suitable materials for the rolls include plastic, metal (e.g., chrome, stainless steel, aluminum, and the like), rubber (e.g., EPDM), ceramic materials, and the like. Furthermore, it is generally noted that the size of the rolls, material of the rolls, number of rolls, the film wrap around the rolls, and the like, can vary with the system employed. Further, it is noted that processing conditions (e.g., the temperature of the calendaring rolls, the line speed, nip pressure, and the like) can also be varied.

Tie layers are optionally used to improve the adhesion between layers. The optional overlay and tie layers can be added by co-extrusion, inline lamination, offline lamination, press lamination, or the like.

The multilayer sheets are transparent, translucent, or opaque. They can be decorated for aesthetics or functionalized to achieve desirable optical or electrical functionality.

The multilayer sheets can be decorated. In use, a surface of the base layer of the multilayer sheet can be subjected to printing with ink. In one embodiment, an exposed surface of the base layer (a surface opposite the surface adjacent to the cap layer) can be subsequently decorated, in particular printed with markings such as alphanumerics, graphics, symbols, indicia, logos, aesthetic designs, multicolored regions, and a combination comprising at least one of the foregoing. The graphic or printed layer can be between two of the base layer sheets.

Those skilled in the art will also appreciate that common curing and surface modification processes including heat-setting, texturing, embossing, corona treatment, flame treatment, plasma treatment, and vacuum deposition can further be applied to the above multilayer sheets to alter surface appearances and impart additional functionalities to the sheets.

Textures can also be imparted to the multilayer sheets using calendaring or embossing techniques. In an embodiment, the molten multilayer sheets can pass through a gap between a pair of rolls with at least one roll having an embossed pattern thereon, to transfer the embossed pattern to a surface of the multilayer sheets. Textures can be applied to control gloss or reflection.

The decoration for the finished article or product can either be exposed to the environment (“first surface decoration”) and/or encapsulated between the decorated sheet and the injected material (“second surface decoration”).

For in-mold decoration (IMD) processes, high temperature, formable inks can be used for graphics application. Second surface decoration can employ more robust ink systems to provide adequate ink adhesion during the molding process. Moreover, in applications such as light assemblies where light transmission is important, dye inks can be used rather than pigmented inks so as not to affect light transmission and haze readings. Once the ink is printed, it can be either dried or cured depending on the ink technology used. If the ink is solvent or water based, then a gas fired or electric dryer can be used to dry the ink.

The multilayer sheets can be functionalized. In an embodiment, a thermoformable electrically conductive ink is applied to a layer of the multilayer sheets by methods such as stamping, screen printing, dripping, syringe dispensing, pad printing, and photo-patterning. The ink can be applied as an unbroken layer or in a pattern. A sheet of the multilayer sheets can also be coated with conductive transparent, electrically conductive coatings for final end use such as electrodes for touch-panel, electroluminescent displays, or capacitive switches as examples. The coating can be applied as an unbroken layer or in a pattern. The conductive coatings are included in the multilayer sheets by roll-to-roll or roll-to-sheet techniques. Depending on the end use, electrically conductive features such as electromagnetic shielding elements, antennas can also be built into the multilayer sheets. The electrically conductive coating, electrically conductive coating ink, electrically conductive feature, integrated circuit, or a combination comprising at least one of the foregoing, can be exterior (on an outer layer), within the multilayer sheet (i.e., coated onto an interior layer), or interior to the sheet, i.e., within one or more sheets. In an embodiment the ink or the coating is applied as an outermost layer of the multilayer sheet. In another embodiment, electrically conductive feature is within a sheet.

Single or multiple layers of coatings can also be applied to one or both sides of the multilayer sheets to impart additional properties such as scratch resistance, ultra violet light resistance, aesthetic appeal, and the like. The coating and/or coatings can be applied to a single layer of extruded thermoplastic composition to generate the multilayer structure. Coatings can be applied through standard application techniques such as rolling, spraying, dipping, brushing, flow coating, or combinations comprising at least one of the foregoing application techniques.

The overall thickness of the multilayer sheet can be up to and even exceeding several millimeters. More specifically, the multilayer sheet can have a thickness (e.g., gage) of 0.24 mil (6 μm) to 500 mils (12,700 μm), more specifically, 2 mils (50 μm) to 40 mils (1016 μm), and yet more specifically, 4 mils (100 μm) to 30 mils (762 μm). The thickness of the various layers will vary depending on the desired weight% of each layer. The cap layer can be 1% to 50%, 5 to 40, or 10 to 30 of overall thickness.

Some examples of the articles include article is a smart card or a component of one or more of the following: an electronic device; imaging device; optical device; light fixture; home appliance; medical device; or automobile. Smart cards such as integrated circuit cards are specifically mentioned.

### EXAMPLES

The materials used in the Examples are described in Table 1.

TABLE 1

| Component | Chemical Description | Source |
|---|---|---|
| CPC-1 | Sebacic acid-bisphenol A polyestercarbonate, | SABIC |
| | produced via interfacial polymerization, | |
| | about 6.0 mol % sebacic acid, Mw about | |
| | 70,000 g/mol as determined via GPC using | |
| | polystyrene standards, para-cumylphenol | |
| | (PCP) end-capped | |
| CPC-2 | Sebacic acid-bisphenol A polyestercarbonate, | SABIC |
| | produced via interfacial polymerization, | |
| | about 6.0 mol % sebacic acid, Mw about | |
| | 37,000 g/mol as determined via GPC using | |
| | polystyrene standards, para-cumylphenol | |
| | (PCP) end-capped | |
| PC-1 | Linear Bisphenol A polycarbonate, produced | SABIC |
| | via interfacial polymerization from bisphenol A, | |
| | Mw about 70,000 g/mol as determined by GPC | |
| | using polystyrene standards, phenol end-capped | |

### Blending, Extrusion, and Molding Conditions

The compositions were made as follows. All solid were dry blended off-line as concentrates using one of the primary polymer powders as a carrier and starve-fed via gravimetric feeder(s) into the feed throat of the extruder. The remaining polymer(s) were starve-fed via gravimetric feeder(s) into the feed throat of the extruder as well. The liquid additives, if any, were fed before the vacuum using a liquid injection system. It will be recognized by one skilled in the art that the method is not limited to these processing steps or processing equipment.

Extrusion of all materials was performed on a 44 mm JSW twin-screw extruder (L/D ratio of 41.9) with a vacuum port located near the die face. The extruder has 12 zones, which were set at temperatures of 280° C. (zone 1 to 12). Screw speed was 280 rpm and throughput was between 70 kg/hr. It will be recognized by one skilled in the art that the method is not limited to these temperatures or processing equipment.

The compositions were molded after drying at 100-120° C. for 6 hours on a 80-ton Toyo molding machine with 36 mm screw or 110-ton Nissei molding machine with 36 mm screw operating at a temperature 260 to 330° C. with a mold temperature of 80 to 100° C. It will be recognized by one skilled in the art that the method is not limited to these temperatures or processing equipment.

### Testing Methods

Heat deflection temperature (HDT) was measured in accordance with ASTM D648 at 1.6 MPa.

Glass transition temperature (Tg) was determined by differential scanning calorimetry (DSC) as per ASTM D3418 with a 20° C./min heating rate.

Melt index (MI) was measured in accordance with ASTM D1238-04 at 300° C. under a load of 1.2 kilogram (kg).

Molecular weight (Mw) determinations were performed using GPC using a cross linked styrene-divinyl benzene column, at a sample concentration of 1 milligram per milliliter, and as calibrated with polystyrene standards. Samples were eluted at a flow rate of 0.6 ml/min with chloroform as the eluent.

Durability was measured by manually bending the sample and counting how many times that the sample could be bended without breakage. The tests were repeated three times.

### Examples 1-7

Examples 1-7 illustrate the properties of poly(aliphatic ester-carbonate)s having relative high and relatively low molecular weights, a bisphenol A homopolycarbonate having a high molecular weight, and the blends thereof. Formulations and results are shown in Table 2.

TABLE 2

| Component | Unit | CEx1 | CEx2 | Ex3 | Ex4 | Ex5 | Ex6 | CEx7 |
|---|---|---|---|---|---|---|---|---|
| CPC-1 | Wt % | | 90 | 100 | 75 | 50 | 25 | |
| CPC-2 | Wt % | 100 | 10 | | | | | |
| PC-1 | Wt % | | | | 25 | 50 | 75 | 100 |
| HDT | ° C. | 119 | 120 | 120 | 124 | 128 | 132 | 136 |
| Tg | ° C. | 134 | 135 | 136 | 140 | 144 | 149 | 154 |
| MI | g/min | 42.6 | 6.6 | 5.7 | 4.8 | 4.1 | 3.4 | 2.8 |
| Mw | g/mol | 36,743 | 64,595 | 67,266 | 67,762 | 68,129 | 69,096 | 69,399 |
| Durability (1.0 mm) | | 5, 4, 4 | 10, 8, 10 | 11, 7, 8 | 8, 6, 6 | 7, 7, 7 | 6, 8, 6 | 7, 6, 7 |
| total of 3 trials | | 13 | 28 | 26 | 20 | 21 | 20 | 20 |
| Durability (1.5 mm) | | 4, 5, 3 | 6, 7, 7 | 8, 8, 8 | 6, 6, 6 | 5, 5, 6 | 7, 7, 8 | 6, 4, 6 |
| total of three trials | | 12 | 19 | 24 | 18 | 16 | 22 | 16 |

The results shown that CPC-1 and blends of CPC-1 and PC-1 have a glass transition temperature of 135 to 149 (Ex 3-Ex 6), which makes them suitable for use in a process requiring a hot press temperature of 130° C. to 150° C.

The results also indicate that CPC-2 is less durable than CPC-1, PC-1, or a blend of CPC-1 and PC-1.

Set forth are various embodiments of the disclosure.

Embodiment 1. A thermoplastic composition comprising, based on the total weight of the composition: 1 to 100 wt. % of a poly(aliphatic ester-carbonate) having a weight average molecular weight of 50,000 g/mol to 200,000 g/mol as measured by gel permeation chromatography using polystyrene standards, the poly(aliphatic ester-carbonate) comprising carbonate units of the formula

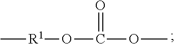

and ester units of the formula

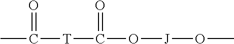

wherein: T is a C₆₋₂₀ alkylene; W is a C₆₋₃₀ aromatic group; and J is a C₂₋₁₀ alkylene, a C₆₋₂₀ cycloalkylene, a C₆₋₂₀ arylene, or a polyoxyalkylene in which the alkylene groups contain 2 to 6 carbons; and 0 to 99 wt. % of a bisphenol A homopolycarbonate having a weight average molecular weight of 50,000 g/mol to 200,000 g/mol as measured by gel permeation chromatography using polystyrene standards; wherein the thermoplastic composition has a heat deflection temperature of 100° C. to 130° C. determined in accordance with ASTM D648 at 1.6 MPa.

Embodiment 2. The thermoplastic composition of Embodiment 1, wherein the poly(aliphatic ester-carbonate) has a weight average molecular weight of 50,000 g/mol to 100,000 g/mol as measured by gel permeation chromatography using polystyrene standards , preferably the poly(aliphatic ester-carbonate) has a weight average molecular weight of 60,000 g/mol to 80,000 g/mol as measured by gel permeation chromatography using polystyrene standards.

Embodiment 3. The thermoplastic composition of Embodiment 1 or Embodiment 2, wherein the thermoplastic composition has a weight average molecular weight of 50,000 g/mol to 200,000 g/mol as measured by gel permeation chromatography using polystyrene standards , preferably a weight average molecular weight of weight average molecular weight of 50,000 g/mol to 200,000 g/mol as measured by gel permeation chromatography using polystyrene standards, more preferably the poly(aliphatic ester-carbonate) has a weight average molecular weight of 60,000 g/mol to 80,000 g/mol as measured by gel permeation chromatography using polystyrene standards.

Embodiment 4. The thermoplastic composition of any one of Embodiments 1 to 3, wherein R¹ and J are each independently derived from a dihydroxy compound of the formula

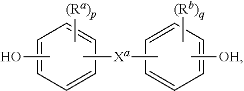

wherein R^{a} and R^{b} are each independently a halogen, C₁₋₁₂ alkoxy, or C₁₋₁₂ alkyl, p and q are each independently integers of 0 to 4, and X^{a} is a single bond, —O—, —S—, —S(O)—, —S(O)₂—, —C(O)—, or a C₁₋₁₈ organic group.

Embodiment 5. The thermoplastic composition of any one of Embodiments 1 to 4, wherein R¹ and J have the formula

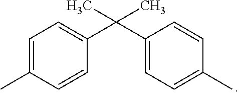

Embodiment 6. The thermoplastic composition of any one of Embodiments 1 to 5, wherein T is a C₆-12 linear alkylene.

Embodiment 7. The thermoplastic composition of any one of Embodiments 1 to 6, wherein T is a linear C₈ alkylene.

Embodiment 8. The thermoplastic composition of any one of Embodiments 1 to 7, wherein the poly(aliphatic ester-carbonate) comprises 1 to 30 mol % of ester units based on the total moles of the carbonate units and ester units in the poly(aliphatic ester-carbonate).

Embodiment 9. The thermoplastic composition of any one of Embodiments 1 to 8, wherein the bisphenol A homopolycarbonate has a weight average molecular weight of 50,000 to 100,000 g/mol measured by gel permeation chromatography using polystyrene standards, preferably the bisphenol A homopolycarbonate has a weight average molecular weight of 60,000 to 80,000 g/mol measured by gel permeation chromatography using polystyrene standards.

Embodiment 10. The thermoplastic composition of any one of Embodiments 1 to 9 comprising 20 to 80 wt. % of the poly(aliphatic ester-carbonate) and 20 to 80 wt. % of the bisphenol A homopolycarbonate based on the total weight of the thermoplastic composition.

Embodiment 11. The thermoplastic composition of any one of Embodiments 1 to 10, wherein the thermoplastic composition has a heat deflection temperature of 110° C. to 120° C. determined in accordance with ASTM D648 at 1.6 MPa.

Embodiment 12. The thermoplastic composition of any one of Embodiments 1 to 11, wherein the thermoplastic composition has a glass transition temperature of 130° C. to 150° C. determined by differential scanning calorimetry as per ASTM D3418 with a 20° C./min heating rate.

Embodiment 13. The thermoplastic composition of any one of Embodiments 1 to 12, wherein a sheet of the thermoplastic composition has no observable specks or gels over an area of at least 3 square meters when viewed at a distance of 0.3 meter without magnification.

Embodiment 14. The thermoplastic composition of any one of Embodiments 1 to 13, wherein an injection molded article of the thermoplastic composition having a thickness of 1.0 mm does not break after bending for 5 times.

Embodiment 15. An article, wherein the article a molded article, a thermoformed article, an extruded sheet, one or more layers of a multi-layer article, a substrate for a coated article, or a substrate for an article made from the thermoplastic composition of any one or more of Embodiments 1 to 14.

Embodiment 16. The article of Embodiment 15, wherein the article is a multi-layer sheet or a heat sensitive pigment containing sheet.

Embodiment 17. The article of Embodiment 16, wherein the multi-layer sheet comprises a base layer comprising the thermoplastic composition and a cap layer disposed on a side of the base layer, the cap layer comprising an acrylic, polyester, or the thermoplastic composition.

Embodiment 18. The article of Embodiment 16 or 17, wherein the multi-layer sheet further comprises an embedded integrated circuit.

Embodiment 19. The article of Embodiment 15 or 16, wherein the article is a smart card or a component of one or more of the following: an electronic device; imaging device; optical device; light fixture; home appliance; medical device; or automobile.

Embodiment 20. A method of manufacturing an article of any one of Embodiments 15 to 19 comprising laminating, extruding or co-extruding, calendaring, injection molding, blow molding, film casting, or coating.

The singular forms “a,” “an,” and “the” include plural referents unless the context clearly dictates otherwise. “Or” means “and/or.” The endpoints of all ranges directed to the same component or property are inclusive and independently combinable. Unless defined otherwise, technical and scientific terms used herein have the same meaning as is commonly understood by one of skill in the art to which this invention belongs. As used herein, a “combination” is inclusive of blends, mixtures, alloys, reaction products, and the like. A “combination thereof” includes any combination comprising at least one of the listed components or properties optionally together with a like component or property not listed.

Compounds are described using standard nomenclature. For example, any position not substituted by any indicated group is understood to have its valency filled by a bond as indicated, or a hydrogen atom. A dash (”-“) that is not between two letters or symbols is used to indicate a point of attachment for a substituent. For example, —CHO is attached through carbon of the carbonyl group.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “alkylidene” refers to a straight or branched chain, saturated divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicylic hydrocarbon group having at least three carbon atoms; “cycloalkylene” refers to a divalent radical formed by the removal of two hydrogen atoms from two different carbon atoms on one or more rings of a cycloalkyl group; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., =O), then two hydrogens on the atom are replaced. Combinations of substituents and/or variables are permissible provided that the substitutions do not significantly adversely affect synthesis or use of the compound. Groups that can be present on a substituted position include (—NO₂), cyano (—CN), hydroxy (—OH), halogen, thiol (—SH), thiocyano (—SCN), C₂₋₆ alkanoyl (e.g., acyl (H₃CC(═O)—); carboxamido; C₁₋₆ or C₁₋₃ alkyl, cycloalkyl, alkenyl, and alkynyl (including groups having at least one unsaturated linkages and from 2 to 8, or 2 to 6 carbon atoms); C₁₋₆ or C₁₋₃ alkoxy; C₆₋₁₀ aryloxy such as phenoxy; C₁₋₆ alkylthio; C₁₋₆ or C₁₋₃ alkylsulfinyl; C₁₋₆ or C₁₋₃ alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇₋₁₉ arylalkyl having 1 to 3 separate or fused rings and from 6 to 18 ring carbon atoms; or arylalkoxy having 1 1 to 3 separate or fused rings and from 6 to 18 ring carbon atoms.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A thermoplastic composition comprising, based on the total weight of the composition:
1 to 100 wt. % of a poly(aliphatic ester-carbonate) having a weight average molecular weight of 50,000 g/mol to 200,000 g/mol as measured by gel permeation chromatography using polystyrene standards, the poly(aliphatic ester-carbonate) comprising carbonate units of the formula 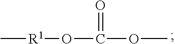
and
ester units of the formula 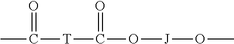
wherein:
T is a C₆₋₂₀ alkylene;
R¹ is a C₆₋₃₀ aromatic group; and
J is a C₂₋₁₀ alkylene, a C₆₋₂₀ cycloalkylene, a C₆₋₂₀ arylene, or a polyoxyalkylene in which the alkylene groups contain 2 to 6 carbons; and
0 to 99 wt. % of a bisphenol A homopolycarbonate having a weight average molecular weight of 50,000 g/mol to 200,000 g/mol as measured by gel permeation chromatography using polystyrene standards;
wherein the thermoplastic composition has a heat deflection temperature of 100° C. to 130° C. determined in accordance with ASTM D648 at 1.6 MPa.

2. The thermoplastic composition of claim 1, wherein the poly(aliphatic ester-carbonate) has a weight average molecular weight of 50,000 g/mol to 100,000 g/mol as measured by gel permeation chromatography using polystyrene standards.

3. The thermoplastic composition of claim 1, wherein the thermoplastic composition has a weight average molecular weight of 50,000 g/mol to 200,000 g/mol as measured by gel permeation chromatography using polystyrene standards.

4. The thermoplastic composition of claim 1, wherein R¹ and J are each independently derived from a dihydroxy compound of the formula 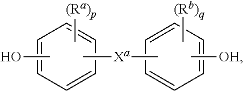
wherein
R^{a} and R^{b} are each independently a halogen, C₁₋₁₂ alkoxy, or C₁₋₁₂ alkyl,
p and q are each independently integers of 0 to 4, and
X^{a} is a single bond, —O—, —S—, —S(O)—, —S(O)₂—, —C(O)—, or a C₁₋₁₈ organic group.

5. The thermoplastic composition of claim 1, wherein R¹ and J have the formula

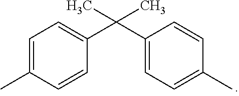

6. The thermoplastic composition of claim 1, wherein T is a C₆₋₁₂ linear alkylene.

7. The thermoplastic composition of claim 1, wherein T is a linear C₈ alkylene.

8. The thermoplastic composition of claim 1, wherein the poly(aliphatic ester-carbonate) comprises 1 to 30 mol % of ester units based on the total moles of the carbonate units and ester units in the poly(aliphatic ester-carbonate).

9. The thermoplastic composition of claim 1, wherein the bisphenol A homopolycarbonate has a weight average molecular weight of 50,000 to 100,000 g/mol measured by gel permeation chromatography using polystyrene standards.

10. The thermoplastic composition of claim 1 comprising 20 to 80 wt. % of the poly(aliphatic ester-carbonate) and 20 to 80 wt. % of the bisphenol A homopolycarbonate based on the total weight of the thermoplastic composition.

11. The thermoplastic composition of claim 1, wherein the thermoplastic composition has a heat deflection temperature of 110° C. to 120° C. determined in accordance with ASTM D648 at 1.6 MPa.

12. The thermoplastic composition of claim 1, wherein the thermoplastic composition has a glass transition temperature of 130° C. to 150° C. determined by differential scanning calorimetry as per ASTM D3418 with a 20° C./min heating rate.

13. The thermoplastic composition of claim 1, wherein a sheet of the thermoplastic composition has no observable specks or gels over an area of at least 3 square meters when viewed at a distance of 0.3 meter without magnification.

14. The thermoplastic composition of claim 1, wherein an injection molded article of the thermoplastic composition having a thickness of 1.0 mm does not break after bending for 5 times.

15. An article, wherein the article a molded article, a thermoformed article, an extruded sheet, one or more layers of a multi-layer article, a substrate for a coated article, or a substrate for an article made from the thermoplastic composition of claim 1.

16. The article of claim 15, wherein the article is a multi-layer sheet or a heat sensitive pigment containing sheet.

17. The article of claim 16, wherein the multi-layer sheet comprises a base layer comprising the thermoplastic composition and a cap layer disposed on a side of the base layer, the cap layer comprising an acrylic, polyester, or the thermoplastic composition.

18. The article of claim 16, wherein the multi-layer sheet further comprises an embedded integrated circuit.

19. The article of claim 15, wherein the article is a smart card or a component of one or more of the following: an electronic device; imaging device; optical device; light fixture; home appliance; medical device; or automobile.

20. A method of manufacturing an article of claim 15 comprising laminating, extruding or co-extruding, calendaring, injection molding, blow molding, film casting, or coating.
